(19) United States
(12) Patent Application Publication
(10) Pub. No.: US 2023/0172228 A1
(43) Pub. Date: Jun. 8, 2023

(54) A PROCESS FOR PREPARING A DEHYDRATED MEAT-ANALOGUE

(71) Applicant: SOCIETE DES PRODUITS NESTLE S.A., Vevey (CH)

(72) Inventors: JIMMY PERDANA, Chicago, IL (US); OLIVER NUSSLI, Chicago, IL (US); VOLKER SCHROEDER, Chicago, IL (US); REINHOLD WILLY BETZ, Gottmadingen (DE); BERND BUECKER, Leingarten (DE); JEAN-MARC BOISSON, Eigeltingen (DE)

(21) Appl. No.: 17/997,834

(22) PCT Filed: May 3, 2021
(86) PCT No.: PCT/EP2021/061580

§ 371 Date: Nov. 3, 2022

(30) Foreign Application Priority Data
May 5, 2020 (EP) 20172884.7

(51) Int. Cl. A23J 3/22; A23J 3/26; A23J 3/14; A23B 7/02

(52) U.S. Cl. CPC A23J 3/227; A23J 3/26; A23J 3/14; A23B 7/02

(57) ABSTRACT

The invention generally relates to a process for preparing a dehydrated meat-analogue. More specifically the invention relates to a process for preparing a dehydrated meat-analogue with a fibrous appearance and good rehydration properties.

The invention generally relates to a process for preparing a dehydrated meat-analogue. More specifically the invention relates to a process for preparing a dehydrated meat-analogue with a fibrous appearance and good drying and rehydration properties.

In recent years, it has become common for consumers to choose foods that are convenient and tasty. However, convenient or ready-to-eat foods tend to be nutritionally unbalanced as they are high in fat and short-chain carbohydrates e.g. refined sugars, and low in dietary fiber and protein. In particularly, it is appreciated that the high fat and low dietary fiber level of these convenient foods can contribute to obesity and various chronic diseases, such as coronary heart disease, stroke, diabetes, and certain types of cancer. It is well known that the primary nutritional features of meat are its protein content. However, the production of meat is relatively inefficient in terms of feed input to food output. Furthermore, some individuals abstain from the consumption of meat for any of a variety of reasons.

It is well known that by supplementing foods with increased levels of dietary fiber and protein, taste can be seriously compromised as off-flavours result in a chalky and bland taste. In addition to the challenges associated with improving taste, it is known that increasing a food's protein level typically results in the loss of the desirable product texture that consumers expect. This is especially critical for dehydrated meat-analogue products.

Hence, there is an existing need in the art and industry to provide a better solution for dehydrated meat-analogues for humans or animals such as pets having a fibrous appearance with good rehydration properties. The dehydrated meat-analogues for humans or animals such as pets having a fibrous appearance as dried real meat with good rehydration properties. There are no dehydrated meat-analogues on the market having such fibrous appearance as dried real meat with good rehydration properties. Good rehydration properties mean, that the rehydration time of the dehydrated meat-analogues is fast e.g. is less then 5 min and the texture after the rehydration is very similar to real meat.

The object of the present invention is to improve the state of the art or at least provide an alternative for a dehydrated meat-analogue: i) a dehydrated meat-analogue for humans or animals such as pets; ii) a dehydrated meat-analogue with a high protein content; iii) a dehydrated meat-analogue with a protein content above 25 wt %, preferably above 40 wt %; iv) a dehydrated meat-analogue having a fibrous appearance with good rehydration properties; v) a dehydrated meat-analogue having a fibrous appearance as dried real meat; vi) a dehydrated meat-analogue having a fibrous appearance having starch or starch flour in a low amount; vii) a dehydrated meat-analogue having a fibrous appearance without having starch or starch flour; viii) a dehydrated meat-analogue having good rehydration properties; ix) a dehydrated meat-analogue having a fibrous appearance as dried real meat with good rehydration properties; x) a dehydrated meat-analogue having a fibrous appearance as dried real meat with good rehydration and textural properties.

The object of the present invention is achieved by the subject matter of the independent claims. The dependent claims further develop the idea of the present invention.

Accordingly, the present invention provides in a first aspect a process for preparing a dehydrated meat-analogue, the process comprising the steps of:
a) feeding an extruder barrel with a composition comprising 40-70 wt % water and 15-35 wt % plant protein;
b) extruding the composition from step a) above the denaturation temperature of the plant protein;
c) cooling the composition from step b) through a cooling die;
d) compress the extruded composition from step c) by applying a compressive force between 250 to 1250 kN/m2;
e) cutting and drying the compressed composition from step d).

In a second aspect, the invention pertains to a dehydrated meat-analogue obtainable by the process comprising the steps of:
a) feeding an extruder barrel with a composition comprising 40-70 wt % water and 15-35 wt % plant protein;
b) extruding the composition from step a) above the denaturation temperature of the plant protein;
c) cooling the composition from step b) through a cooling die;
d) compress the extruded composition from step c) by applying a compressive force between 250 to 1250 kN/m2;
e) cutting and drying the compressed composition from step d).

It has been surprisingly found by the inventors that by using the above-mentioned process a dehydrated meat-analogue having a fibrous appearance and good rehydration properties can be obtained. Due to the fibrous appearance the obtained vegetarian dehydrated meat-analogue looks like dried real meat. The process of the present disclosure allows the continuous production of a dehydrated meat-analogue that has the fibrous appearance of real dried meat with good rehydration properties using extrusion technology. It has now been found by the inventors that applying a compressive force between 250 to 1250 kN/m2 to the cooled extrudates surprisingly has a beneficial effect regarding the dehydration process and rehydration properties of a meat-analogue product.

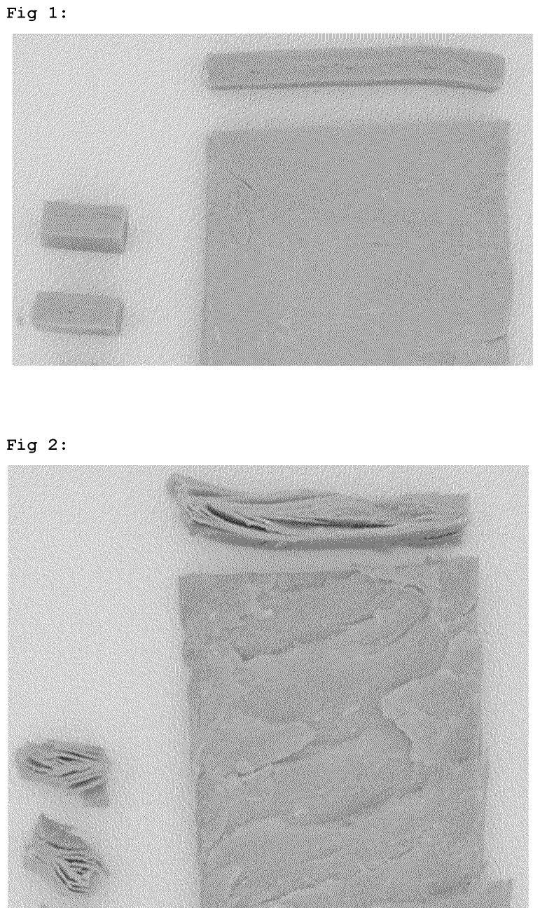

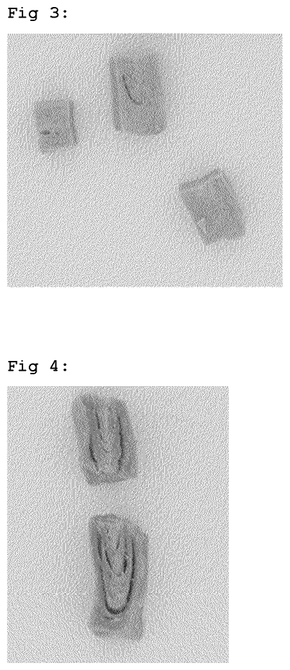

As generally illustrated in FIG. 1 to FIG. 4, the present disclosure provides a process for producing meat-analogue food product having a fluffier texture compared to a standard process without applying a compressive force showing a denser texture.

The dehydrated meat-analogue can be further enhanced by adding oil, flavouring systems, fillers, colouring, and/or texturization agent and can be fortified to improve the nutritional value of the product. It results in a dehydrated meat-analogue having the fibrous appearance of real dried texture and taste of meat and having good rehydration and sensory properties.

In case oil or fat or a combination thereof is required in the final product a better fibrous product is achieved through an oil injection down-stream of the feeding location of the plant protein and water in the extruder barrel as described in WO2016150834. In addition, many flavour and/or fortification compounds are soluble within oil but not within water. Therefore, it is a very convenient way to introduce such compounds within the composition. The oil injection further reduces the need to use starch and/or flour, which is normally responsible to absorb the oil for better processing. A meat-analogue having high amount of starch and/or flour are perceived with a negative mouth feeling and a cereal taste and aroma which are not pleasant for the consumer.

All percentages expressed herein are by weight of the total weight of the dehydrated meat-analogue unless expressed otherwise.

The terms “food,” “food product” and “food composition” mean a product or composition that is intended for ingestion by an animal, including a human, and provides at least one nutrient to the animal or human. The present disclosure is not limited to a specific animal. The term “pet food” means any composition intended to be consumed by a pet.

The term “pet” means any animal which could benefit from or enjoy the compositions provided by the present disclosure. For example, the pet can be an avian, bovine, canine, equine, feline, hircine, lupine, murine, ovine, or porcine animal, but the pet can be any suitable animal. The term “companion animal” means a dog or a cat.

A “meat-analogue” is a composition in which meat (i.e. skeletal tissue and non-skeletal muscle from mammals, fish and fowl) and meat by-products (i.e. the non-rendered clean parts, other than meat, derived from slaughtered mammals, fowl or fish) are completely absent.

By “dehydrated” it is meant that said meat analogue is shelf-stable. By “shelf-stable” is meant that the said meat analogue can be safely stored at room temperature in a sealed pack. Particularly, the meat-analogue can be safely stored for at least 3 months, preferably for at least 6 months, preferably for at least 9 months, more preferably for at least 12 months at a room temperature of 25° C. Within the said shelf-stable period, the meat-analogue maintains its organoleptic stability as well as its microbiological safety. During that period the meat-analogue remains its described fibrous appearance and rehydration functionality.

“Extrusion” is a process used to create objects of a fixed cross-sectional profile. A material is pushed or pulled through a die of the desired cross-section. The two main advantages of this process over other manufacturing processes are its ability to create very complex cross-sections, and to prepare products that are brittle, because the material only encounters compressive and shear stresses. High-moisture extrusion is known as wet extrusion. Extruders typically comprise an extruder barrel within which rotates a close-fitting screw. The screw is made up of screw elements, some of which are helical screw threads to move material through the extruder barrel. Material is introduced into the extruder barrel toward one end, moved along the extruder barrel by the action of the screw and is forced out of the extruder barrel through a nozzle or die at the other end. The rotating screw mixes and works the material in the barrel and compresses it to force it through the die or nozzle. The degree of mixing and work to which the material is subjected, the speed of movement of the material through the extruder barrel and thus the residence time in the extruder barrel and the pressure developed in the extruder barrel can be controlled by the pitch of the screw thread elements, the speed of rotation of the screw and the rate of introduction of material into the extruder barrel. The extruder barrel comprises multiple extruder barrel sections which are joined end to end. Multiple extruder barrel sections are required to carry out different processes involved in extrusion such as conveying, kneading, mixing, devolatilizing, metering and the like. Each extruder barrel section comprises a liner which is press fit into an extruder barrel casing, and heating and cooling elements are provided to regulate temperature of extruder barrel section within permissible range. The total length of an extrusion process can be defined by its modular extrusion barrel length. An extruder barrel is described by its unit of diameter. A “cooling die” is cooling the extruded product to a desired temperature.

Further ingredients selected from flavouring, filler and/or optionally fortification compounds can be added to plant protein when feeding the extruder in step a).

In a further embodiment water might be mixed to a dry plant protein before feeding the extruder barrels through a slurry inlet.

In a further embodiment plant protein in the form of a dry powder is added to the extruder barrel and water is injected separately. The mixing of the dry plant protein and water is done within the extruder barrel through the mechanical energy forced. Therefore, it is not necessary to form a dough of the plant protein and water before feeding the extruder barrel.

The term “plant protein” includes “plant protein isolates” or “plant protein concentrates” or combination thereof. The person skilled in the art knows how to calculate the amount of plant protein within a plant protein concentrate or plant protein isolate.

The term “plant protein concentrate” as used herein is a plant material having a protein content of from about 65% to less than about 90% plant protein on a moisture-free basis. Plant protein concentrate also contains plant fiber, typically from about 3.5% up to about 20% by weight on a moisture-free basis. The term plant protein isolate as used herein is a plant material having a protein content of at least about 90% plant protein on a moisture free basis.

Plant protein include plant protein concentrate or plant protein isolate from pea protein, corn protein (e.g., ground corn or corn gluten), wheat protein (e.g., ground wheat or wheat gluten such as vital wheat gluten), potato protein, legume protein such as soy protein (e.g., soybean meal, soy concentrate, or soy isolate), rice protein (e.g., ground rice or rice gluten), barley protein, algae protein, hemp protein, oat protein, canola protein, fava protein or combinations thereof. Preferably the plant protein is wheat gluten, pea protein, canola protein, hemp protein, soy protein or a combination thereof, more preferably pea protein or soy protein. In a further embodiment, the dehydrated meat-analogue of the invention comprises plant protein within step a) in the amount of 15-35 wt %, preferably 17-32 wt %, preferably 17-30 wt %, preferably 17-28 wt %, preferably 18-24 wt %.

In a further embodiment, the dehydrated meat-analogue of the invention comprises soy or pea protein within step a) in the amount of 15-35 wt %, preferably 17-32 wt %, preferably 17-30 wt %, preferably 17-28 wt %, preferably 18-25 wt %.

In a further embodiment, the dehydrated meat-analogue of the invention comprises soy protein and wheat gluten within step a) in the amount of 15-35 wt %, preferably 17-32 wt %, preferably 17-30 wt %, preferably 17-28 wt %, preferably 18-25 wt %.

In a further embodiment, the dehydrated meat-analogue of the invention comprises water within step a) in the amount of 40-70 wt %, preferably 45-70 wt %, preferably 45-65 wt %, preferably 50-70 wt %, preferably 50-65 wt %, preferably 55-65 wt %.

In a further embodiment, the dehydrated meat-analogue of the invention comprises liquid oil, fat or a combination thereof in an amount of 1.5-10 wt %, preferably 2-10 wt %, preferably 2-8 wt %, preferably 2-7 wt %, preferably 3-8 wt %, preferably 3-7 wt %. In an embodiment of the invention the liquid oil, fat or a combination thereof is injected into the extruder barrel at a location down-stream of the feeding location of step a). The process of oil-injection is described in WO2016150834.

The term liquid oil, fat or combination thereof include soybean oil, corn oil, sunflower oil, high oleic sunflower oil, olive oil, canola oil, safflower oil, peanut oil, palm oil, cottonseed oil, coconut oil, almond oil, hazelnut oil, rape seed oil, fractionated palm fat, fully or partially hydrogenated or inter-esterified palm oil and combinations thereof. Preferably the liquid oil is sunflower oil.

The term “flavouring” in the context of this invention includes salt, flavouring agents, acids, taste enhancing ingredients, herbs, spices, vegetables or mixtures thereof, which are suitable for being used in a food product. Taste enhancing ingredients may be provided by monosodium glutamate (MSG) and/or yeast extract etc. Salt refers to any suitable alkali metal salt or mixture thereof. The salt used in the composition of this invention is typically, but not limited to, sodium chloride. For example, potassium chloride may be used or any low-sodium product having a taste impression of sodium chloride may be used, as long as the taste in the end formulation is acceptable. Acids may be provided by vinegar, lactic acid, citric acid or combination thereof.

In a further embodiment, the dehydrated meat-analogue of the invention comprises flavouring in the amount of 0.5-20 wt %, preferably 0.5-15 wt %, preferably 0.5-10 wt %, preferably 2-10 wt %, preferably 2-8 wt %, preferably 3-8 wt %.

The term “filler” in the content of this invention includes carbohydrates. Carbohydrates may be provided by starches, flours, sugars, maltodextrins, glucose syrups etc., preferably maltodextrin. Starches and/or flours include those from rice, wheat, corn, barley, and sorghum, potato, cassava, sweet potato, arrowroot, yam, pea, chickpea, mung beans or lentil or any combination thereof.

In a further embodiment, the dehydrated meat-analogue of the invention comprises fillers in the range 0.5 to 10 wt %, 0.5-8 wt %, preferably 0.5-7 wt %, preferably 1-10 wt %, preferably 1-8 wt %, preferably 1-7 wt %, preferably 2-7 wt %, preferably 0.5-6 wt %, preferably 0.5-5 wt %, preferably 0.5-4 wt %, preferably 0.5-3 wt %.

In a further embodiment, the dehydrated meat-analogue of the invention comprises starch and/or flour as filler in the range 0-7 wt %, preferably 0-6 wt %, preferably 0-5 wt %, preferably 0-4 wt %, preferably 0-3 wt %, preferably 0.1-7 wt %, preferably 0.1-6 wt %, preferably 0.1-5 wt %, preferably 0.1-4 wt %, preferably 0.1-3 wt %, preferably 1-7 wt %, preferably 1-8 wt %, preferably 1-6 wt %, preferably 1-5 wt %.

In an embodiment of the invention, the dehydrated meat-analogue comprise one or more fortification compounds as vitamins, minerals and iron salts. The term vitamins include Vitamins A, B-complex (such as B-1, B-2, B-6 and B-12), C, D, E and K, niacin, and acid vitamins such as pantothenic acid, folic acid and biotin, preferably vitamin B-12. The term minerals include calcium, iron, zinc, magnesium, iodine, copper, phosphorus, manganese, potassium, chromium, molybdenum, selenium, nickel, tin, silicon or vanadium. The term iron salts include ferric sodium EDTA, reduced iron, ferrous lactate, ferric citrate, ferric pyrophosphate, ferrous sulphate monohydrate or ferric ammonium citrate brown, preferably ferric pyrophosphate. Specific amounts of fortification compounds will depend on a variety of factors such as the identity of the ingredient; the species of animal; the animal's age, body weight, general health, sex, and diet; the animal's consumption rate; the purpose for which the food product is administered to the animal; and the like. Therefore, the components and their amounts may vary widely.

In an embodiment the dehydrated meat-analogue can also comprise one or more colours. The term colours include FD&C colors, such as blue no. 1, blue no. 2, green no. 3, red no. 3, red no. 40, yellow no. 5, yellow no. 6, and the like; natural colors, such as caramel coloring, annatto, chlorophyllin, cochineal, betanin, turmeric, saffron, paprika, lycopene, elderberry juice, pandan, butterfly pea and the like; titanium dioxide; and any suitable food colorant known to the skilled artisan.

In a further embodiment, the dehydrated meat-analogue has a protein content of at least 25 wt %, preferably at least 30 wt %, preferably at least 35 wt %, preferably at least 40 wt %, and a water activity less than 0.6, preferably less than 0.4, more preferably less than 0.3 after drying. In a further embodiment, the dehydrated meat-analogue has a protein content between 25 to 80 wt %, preferably between 30 to 80 wt %, preferably between 35 to 80 wt %, preferably between 40 to 80 wt %. In a further embodiment, the dehydrated meat-analogue has a water activity less than 0.6 after drying, preferably less than 0.4, more preferably less than 0.3, preferably between 0.1 to 0.6, preferably between 0.1 to 0.4, preferably between 0.1 to 0.3. In a further embodiment, the dehydrated meat-analogue has a protein content between 40 to 80 wt % and a water activity less than 0.6 after drying, preferably less than 0.3, preferably between 0.1 to 0.6, preferably between 0.1 to 0.5, preferably between 0.1 to 0.35, preferably between 0.1 to 0.3. In a further embodiment, the dehydrated meat-analogue has a protein content between 40 to 80 wt % and a moisture content between 0.5 to 11.5 wt %, preferably between 0.5 to 9 wt %, preferably between 0.5 to 7 wt %, preferably between 0.5 to 5 wt %.

In case the plant protein is mixed with water before feeding the extruder barrel, the non-meat dough can be transferred, for example by pumping, from the mixing device. In an embodiment, the non-meat dough is transferred directly from the mixing device to the extruder barrel without any other processing or addition or removal of ingredients.

In case the plant protein is added as dry mix to the extruder barrel, a hopper might be used. Water is added separately to the extruder barrel.

The extruder barrels are heated to a temperature of between 70 to 300° C., preferably 80 to 180° C., preferably 80-150° C. The pressure on the front plate (between last extruder barrel and cooling die) is between 10 to 40 bar, preferably 15 bar. The screw speed is around 200-600 rpm.

During the cooling within the cooling die both the temperature and the pressure are gradually reduced as the heated non-meat dough travels through the cooling device. The dough has moisture and is under elevated temperature, so preferably moisture flashing is controlled to avoid rapid expansion of the food product. Product expansion that is too rapid can disrupt the structure of the texturized food product. However, depending on the desired image of the final food product, some flashing may be required to reduce the temperature of the centre of the food product and/or to expose some of the fibers in the food product. In an embodiment, the extruded mixture undergoes a decrease in pressure at a predetermine rate in the cooling device and/or is subjected to a predetermined final pressure at the end of the cooling device. The extruded mixture has an exit temperature at the end of the cooling die between 40-110° C., preferably between 50-100° C., preferably between 50-95° C., preferably between 50-90° C., preferably between 70-110° C., preferably between 70-100° C., preferably between 70-95° C.

After cooling within the cooling die the extruded mixture needs to be compressed. The word compressed means also that a partly sheared force can be applied or any combination thereof. Compressive force means compressed or sheared or any combination thereof. The compressive force is applied by rolling or pressing or shearing or any combination thereof, wherein the compressive force (force normalised to surface area) is between 250 to 1250 kN/m2, preferably between 300 to 1100 kN/m2, preferably between 300 to 1000 kN/m2, preferably between 350 to 1100 kN/m2, preferably between 350 to 1000 kN/m2, preferably between 400 to 1000 kN/m2, preferably between 400 to 900 kN/m2. In case the is below the mentioned value of 250 kN/m2, required drying time of the meat analogue is prolonged, and the rehydration time of the dehydrated meat-analogue product is getting longer e.g. more than 5 min. In case the compressive force is above the mentioned value of 1250 kN/m2 more fines are obtained, which should be avoided to result in a product with homogenous appearance. Too many fines are perceived by the consumer as a low value product and should be avoided. The fines of the dehydrated meat-analogue may be defined to have a size after drying with a dimension or Dv50 mentioned below.

In an alternative embodiment the compressive force is between 100 to 500N, preferably between 100 to 450N, preferably between 120 to 500N, preferably between 120 to 450N, preferably between 150 to 400N.

In a further alternative embodiment the compressive force is defined as

$$compressive force = \frac{[ initial product thickness - product thickness during compressing ]}{initial product thickness}$$

and wherein the compressive or pressing force is between 30 to 75%, preferably between 35 to 75%, preferably between 30 to 70%, preferably between 35 to 70%, preferably between 40 to 70%. Initial product thickness is the thickness of the meat analogue after cooling and before compressing, for example 10 mm. The meat analogue is compressed between two rolls having a gap size, for example a gap size of 5 mm. The gap size of the two rolls are also the product thickness during compressing. Therefore, the compressive force based on the product thickness measurements would be in this case 50%.

The term “cutting” means that the meat-analogue can be sliced, cut, ground, shredded, grated or a combination thereof. Cutting can be done with static, rotating or vibrating knives having vertical, horizontal and/or diagonal knives, depending on the shape of the food product to be manufactured.

After cutting the protein snack product is dried. The drying is selected from air drying, hot air drying, oven drying, microwave drying, freeze drying, vacuum belt drying, vacuum oven drying, vacuum microwave drying, vacuum infrared drying, dielectric drying, supercritical drying. In a preferably embodiment of the invention the drying is step is a hot air drying step, air drying or vacuum drying, preferably hot air drying. The vacuum drying is selected from vacuum belt drying, vacuum oven drying, vacuum microwave drying, vacuum infrared drying or combinations thereof. After drying the dehydrated meat-analogue has a water activity less than 0.6, preferably less than 0.3, preferably between 0.1 to 0.6, preferably between 0.1 to 0.5, preferably between 0.1 to 0.35, preferably between 0.1 to 0.3. In an embodiment the dehydrated meat-analogue has after drying a moisture content between 0.5 to 11.5 wt %, preferably between 0.5 to 9 wt %, preferably between 0.5 to 7 wt %, preferably between 0.5 to 5 wt %.

In an embodiment the dehydrated meat-analogue has a size after drying with the dimension of length 5 to 70 mm, width 1 to 50 mm and thickness 0.1 to 20 mm, preferably the dimension of length 9 to 50 mm, width 3 to 50 mm and thickness 1 to 20 mm, preferably the dimension of length 9 to 60 mm, width 5 to 50 mm and thickness 2 to 20 mm. In an embodiment the dehydrated meat-analogue has a size after drying of Dv50 between 1 to 70 mm, preferably between 2 to 70 mm, preferably between 3 to 70 mm, preferably between 3 to 50 mm.

The particle size Dv50 is used in the conventional sense as the median of the particle size distribution. Median values are defined as the value where half of the population reside above this point, and half resides below this point. The Dv50 is the size in millimeter that splits the volume distribution with half above and half below this diameter. The particle size distribution may be measured by for example photoanalysis or sieving. For example, the particle size distribution may be measured by sieving. Appropriate set of sieve sizes can result in a volume distribution, the Dv50 cited is the volume median.

The dehydrated meat-analogue can be filled and sealed into a package. Non-limiting examples of suitable packaging types include cans, pouches, glass container, plastic containers.

Those skilled in the art will understand that they can freely combine all features of the present invention disclosed herein. In particular, features described for the composition of the present invention may be combined with the process for the preparation of the composition, and vice versa. Further, features described for different embodiments of the present invention may be combined. Further advantages and features of the present invention are apparent from the examples. It will be appreciated that the invention as claimed is not intended to be limited in any way by these examples.

### EXAMPLES

Compressive force applied during compressing was measured off-line. A sheet of meat analogue was cut into 2×2 cm in length and width direction. The meat analogue then applied to a compression test

carried out using Texture Analyser TA-HDplus (Stable Micro System, UK) equipped with 250 kg load cell and P/75 compression platen. Texture Analyser test mode was set to “Compression” with pre-test speed of 1 mm/s, test speed of 0.5 mm/s, post-test speed of 10 mm/s, target mode of “Distance”. Distance was varied to mimic the gap size between roller in Sewer-Rondo SFA 69, i.e. between 2 and 8 mm. Halt time was set to “No”, way back of 10 mm, trigger type to “Auto(Force), and trigger force of 50 gram. Meat analogue sample was placed centrally, and compression was applied into the thickness direction. Compression measurement was carried out in 6 replications.

Comparison between roller gap diameter and Compression measurement is presented in the table below. As the surface area of the sample is fixed at 2×2 cm, the compressive stress can be measure as:

Compressive stress=compressive force/area

| Gap size | Average | Compressive |
|---|---|---|
| between roller | Force | stress |
| (mm) | (N) | (kN/m2) |
| 8 | 38 | 95 |
| 7 | 64 | 161 |
| 6 | 147 | 367 |
| 5 | 186 | 465 |
| 4 | 247 | 617 |
| 3 | 384 | 959 |
| 2 | 542 | 1355 |

The median particle diameter Dv50 is used in the conventional sense as the median of the particle size distribution. Median values are defined as the value where half of the population resides above this point, and half resides below this point. The Dv50 is the size that splits the distribution with half above and half below this diameter. The particle size distribution Dv50 has been measured within this invention by selected sieves. In an embodiment the particle size Dv50 has been measured by selected sieves according to Retsch AS200.

Water activity was measured according to ISO 18787:2017 using Hygrolab HC2-AW-USB at a controlled temperature of 25° C. with WP-40TH sample holder connected to water bath and equipped with AW-KHS clamp (Rotronic AG, Switzerland).

Moisture content was determined thermogravimetrically. Approx. 30 gram of dried meat analogue sample was ground using Retsch Grindomix GM200 for 30 second at 5000 RPM. An aluminum crucible medium (100 μL volume, Mettler-Toledo, USA) and an aluminum piercing lid (Mettler-Toledo, USA) were weighed in an AX-205 balance (Mettler-Toledo, USA); recorded with 0.01 mg accuracy. Approximately 20 μg of ground meat analogue sample was placed in the aluminum crucible. Then, the crucible was hermetically sealed with the aluminium piercing lid. The sealed crucible was re-weighed with 0.01 mg accuracy. The exact sample weight was then determined as mass difference between the first and second weighing.

Crucibles were then placed in an auto-sampler turntable of Thermogravimetric Analysis-Differential Scanning calorimetry (TGA-DSC1, Mettler-Toledo, USA). The auto-sampler was equipped with a piercing kit, which automatically pierced the crucible immediately before transferring the crucible into the TGA measuring cell. Thermogravimetric measurement was carried out between 30 and 240° C. with heating rate set to 2° C./minute. End temperature of drying (complete removal of all moisture from sample) was determined at temperature where change in sample weight with temperature increase is at minimum following the method proposed by Vuataz and coworkers (G. Vuataz, V. Meunier, J. C. Andrieux, TG-DTA approach for designing reference methods for moisture content determination in food powders, Food Chemistry, Volume 122, Issue 2, 2010). Sample dry weight is determined at end temperature of drying. Moisture content was then determined as:

Moisture content=(Sample initial weight−sample dry weight)/sample initial weight

Rehydration time was determined sensorially. Thirty gram of dried samples were placed in a bowl. 200 mL of boiling water was poured onto the sample. Pieces of samples were taken out every 15 second from the bowl for sensory test. For longer rehydration time, sampling time was then adjusted accordingly. Full rehydration was determined by three experienced panelists where the texture match the texture of original (non-dried) meat analogue.

### Example 1

The examples are describing the preparation of a dehydrated meat-analogue by the process of this invention. A dry mix of the plant protein was added through a hopper into the extruder barrel and water is separately injected at room temperature. The extruder barrels are heated within a curve between 80-150° C. The cooling die is cooling the extruded mixture to an exit temperature of 70° C. The extruded product is compressed (sheared) with Sewer-Rondo SFA 69 dough sheeter and afterwards cut and dried using a hot air dryer (Afrem International SA, France). The product was made on a Bühler BCTL-42 twin screw extruder from the following materials:

| Ingredient | % (w/w) |
|---|---|
| Water | 63 |
| Soy Protein concentrate | 33 |
| Starch or Flour | 0 |
| Flavouring | 4 |
| Total Protein content | 23.1 |
| from concentrate | |

### Examples 2-14

The obtained product from example 1 has been used to dry the meat-analogue product according to the following parameter:

| | Comp. | Comp. | Comp. | |
|---|---|---|---|---|
| | Exam- | Exam- | Exam- | Exam- |
| | ple 2 | ple 3 | ple 4 | ple 5 |
| Compressive force (kN/m2) | — | — | — | 465 |
| Air drying temp. [° C.] | 105 | 105 | 120 | 105 |
| Drying time [min] | 30 | 60 | 40 | 30 |
| Product median diameter (D50) | 8 | 8 | 8 | 8 |
| [mm] | | | | |
| Moisture content [wt %] | 12.28 | 3.79 | 6.57 | 3.66 |
| Aw | 0.62 | 0.13 | 0.41 | 0.13 |
| Rehydration time [min] | 9 | 7 | 10 | 2.5 |
| Sensory | | | | |

| | Comp. | | |
|---|---|---|---|
| | Example 6 | Example 7 | Example 8 |
| Compressive force(kN/m2) | 150 | 367 | 514 |
| Air drying temp. [° C.] | 105 | 105 | 105 |
| Drying time [min] | 30 | 30 | 30 |
| Sieve median diameter (D50) | 8 | 8 | 8 |
| [mm] | | | |
| Moisture content [wt %] | 10.20 | 5.09 | 3.5 |
| aw | 0.57 | 0.20 | 0.13 |
| Rehydration time [min] | 7.0 | 3.5 | 3.0 |
| Sensory | | | |

| | | Comp. |
|---|---|---|
| | Example 9 | Example 10 |
| Compressive force(kN/m2) | 617 | 1355 |
| Air drying temp. [° C.] | 105 | 105 |
| Drying time [min] | 30 | 30 |
| Sieve median diameter (D50) | 8 | 8 |
| [mm] | | |
| Moisture content [wt %] | 3.4 | 2.85 |
| aw | 0.12 | 0.10 |
| Rehydration time [min] | 2.5 | 2.5 |
| Sensory | | Too many |
| | | fine particles, |
| | | less fibrous |
| | | meat bites |

| | Comp. | | Comp. | |
|---|---|---|---|---|
| | Exam- | Exam- | Exam- | Exam- |
| | ple 11 | ple 12 | ple 13 | ple 14 |
| Compressive force | — | 465 | — | 465 |
| Vacuum drying temp. [° C.] | 90 | 90 | — | — |
| Oven drying temp. [° C.] | — | — | 120 | 120 |
| Sieve median diameter (D50) | 8 | 8 | 8 | 8 |
| [mm] | | | | |
| Drying time [min] | 120 | 90 | 60 | 60 |
| Moisture content | 5.68 | 6.75 | 5.48 | 1.67 |
| aw | 0.31 | 0.33 | 0.20 | 0.10 |
| Rehydration time [min] | 12 | 3 | 14 | 4.5 |

Examples 5, 7-9, 12 and 14 are examples according to the present invention showing that applying a compressive force has a surprising effect having a fibrous appearance of real meat with faster dehydration and rehydration times. Comparison example 10 applies a compressive force below the claimed invention and comparison example 16 above the claimed invention.

### Example 15-16

Following the process of example 1 an extruded product has been obtained from the following materials:

| Ingredient | % (w/w) |
|---|---|
| Water | 51 |
| Soy Protein concentrate | 43 |
| Starch or Flour | 2 |
| Flavouring | 4 |
| Total Protein content | 30.1 |
| from concentrate | |

| | Comp. | |
|---|---|---|
| | Example 15 | Example 16 |
| Compressive force | — | 465 |
| Air drying temp. [° C.] | 105 | 105 |
| Drying time [min] | 30 | 30 |
| Sieve median diameter (D50) | 8 | 8 |
| [mm] | | |
| Moisture content | 14.50 | 4.6 |
| aw | 0.67 | 0.24 |
| Rehydration time [min] | 15 | 3.5 |

Example 16 is an example according to the present invention showing that applying a compressive force has a surprising effect having a fibrous appearance of real meat with a faster dehydration and rehydration time.

### Example 17-18

Following the process of example 1 an extruded product has been obtained from the following materials:

| Ingredient | % (w/w) |
|---|---|
| Water | 55 |
| Soy Protein concentrate | 30 |
| Wheat Gluten Protein | 10 |
| concentrate | |
| Starch or Flour | 0 |
| Flavouring | 5 |
| Total Protein content | 29.3 |
| from concentrate | |

| | Comp. | |
|---|---|---|
| | Example 17 | Example 18 |
| Compressive force | — | 465 |
| Air drying temp. [° C.] | 105 | 105 |
| Drying time [min] | 30 | 30 |
| Sieve median diameter (D50) | 8 | 8 |
| [mm] | | |
| Moisture content | 13.20 | 3.80 |
| aw | 0.65 | 0.24 |
| Rehydration time [min] | 13 | 3.0 |

Example 18 is an example according to the present invention showing that applying a compressive force has a surprising effect having a fibrous appearance of real meat with a faster dehydration and rehydration time.

### Example 19-20

Following the process of example 1 an extruded product has been obtained from the following materials:

| Ingredient | % (w/w) |
|---|---|
| Water | 50 |
| Pea Protein isolate | 41 |
| Starch or Flour | 0 |
| Sunflower oil | 3 |
| Flavouring | 6 |
| Total Protein content | 36.5 |
| from concentrate | |

| | Comp. | |
|---|---|---|
| | Example 19 | Example 20 |
| Compressive force | — | 465 |
| Air drying temp. [° C.] | 105 | 105 |
| Drying time [min] | 30 | 30 |
| Moisture content | 15.00 | 3.60 |
| aw | 0.64 | 0.22 |
| Rehydration time [min] | 8 | 3 |

Example 20 is an example according to the present invention showing that applying a compressive force has a surprising effect having a fibrous appearance of real meat with a faster dehydration and rehydration time.

1. A process for preparing a dehydrated meat-analogue, the process comprising the steps of:
a) feeding an extruder barrel with a composition comprising 40-70 wt % water and 15-35 wt % plant protein;
b) extruding the composition from step a) above the denaturation temperature of the plant protein;
c) cooling the composition from step b) through a cooling die;
d) compressing the extruded composition from step c) by applying a compressive force between 250 to 1250 kN/m2; and
e) cutting and/or drying the compressed cooled composition from step d).

2. The process for preparing a dehydrated meat-analogue according to claim 1, wherein the dehydrated meat-analogue does not comprise protein from an animal source.

3. The process for preparing a dehydrated meat-analogue according to claim 1 further comprises feeding the extruder barrel with flavouring and/or filler.

4. The process for preparing a dehydrated meat-analogue according to claim 3, wherein the amount of flavouring is in the range of 0.5 to 15 wt %.

5. The process for preparing a dehydrated meat-analogue according to claim 3, wherein the amount of filler is in the range of 0.5 to 15 wt %.

6. The process for preparing a dehydrated meat-analogue according to claim 1, wherein the plant protein is mixed with the water before feeding the extruder barrels.

7. The process for preparing a dehydrated meat-analogue according to claim 1, wherein the plant protein is added to the extruder barrel in the form of a dry powder and water is injected separately into the extruder barrel.

8. The process for preparing a dehydrated meat-analogue according to claim 1, wherein the plant protein is selected from the group consisting of soy protein, pea protein, canola protein, hemp protein, oat protein or wheat gluten, and a combination thereof.

9. The process for preparing a dehydrated meat-analogue according to claim 1, wherein the extruder barrels are heated to a temperature between 80-300° C.

10. The process for preparing a dehydrated meat-analogue according to claim 1, wherein the extruded mixture has an exit temperature at the end of the cooling die between 50-110° C.

11. The process according to claim 1, wherein the drying is selected from hot air drying.

12. A dehydrated meat-analogue obtainable by the process of claim 1.

13. A dehydrated meat-analogue of claim 12 wherein the dehydrated meat-analogue has a protein content after drying of at least 40 wt %.

14. A dehydrated meat-analogue as claimed in claim 12 wherein the dehydrated meat-analogue after drying has a water activity less than 0.6.
